(19) United States
(12) Patent Application Publication
(10) Pub. No.: US 2025/0292139 A1
(43) Pub. Date: Sep. 18, 2025

(54) MINOR EMBEDDING POST-PROCESSING TO REDUCE PHYSICAL QUBITS

(71) Applicant: Dell Products L.P., Round Rock, TX (US)

(72) Inventors: Miguel Paredes Quiñones, Campinas (BR); Ítalo Gomes Santana, Rio de Janeiro (BR); Diego Vrague Noble, Pelotas (BR)

(21) Appl. No.: 18/605,704

(22) Filed: Mar. 14, 2024

(51) Int. Cl. G06N 10/60; G06N 10/20; G06N 10/40

(52) U.S. Cl. CPC G06N 10/60; G06N 10/20; G06N 10/40

(57) ABSTRACT

One example method includes ranking all edges e of a graph G that was obtained using a minor embedding process performed on a graph topology Q, and the ranked edges are included in a list R, creating a graph G′ by copying G, and for each of the edges e, performing, for as long as a stop criterion has not been met, operations that include: identifying nodes and edges in the graph G′, removing, from the graph G′, any edges that meet an adjacency criterion, and placing the removed edges in a set B′ of edges, removing, from the list R, all edges of the B′ of edges, and removing, from the graph G′, the edge e.

### FIELD OF THE INVENTION

Embodiments of the present invention generally relate to mapping of QUBO (quadratic unconstrained binary optimization) graph nodes to qubits implemented in hardware. More particularly, at least some embodiments of the invention relate to systems, hardware, software, computer-readable media, and methods, for a post-processing approach for reducing a number of qubits needed to solve a QUBO or other problem.

### BACKGROUND

Currently, no Quantum Annealer (QA) vendor provides a hardware capable of accommodating any input graph without modifications, making the minor-embedding a mandatory task for practically most graphs as the design of a quantum processor unit (QPU) with fully connected qubits is infeasible. This is because for each new qubit added, one would need to add a new edge in the hardware connecting this qubit to all other qubits. Unsurprisingly, this does not escalate well for systems with large number of qubits, as a fully connected graph requires all pairs of n vertices to be connected, resulting in

$$( \begin{matrix}n \\ 2\end{matrix} ) = n ( n - 1 ) / 2$$

edges in total.

The minor embedding problem appears when a QUBO or Ising model is embedded onto a QPU architecture with minimal use of the set of qubits, that is, the minor-embedding problem aims at finding the most efficient mapping in the number of used qubits between the graph representing the QUBO and the graph of qubits implemented in the hardware. This problem, however, is NP-hard, making non-exact methods, such as heuristics for example, able to address this problem in practical running time at the cost of solution quality. With no optimal guarantees, the resulting mapping is often ill-conceived, thus, using more resources, that is, qubits, than needed to solve the underlying QUBO problem, or other problem. Even with recent advancements for minor-embedding heuristics, these algorithms will be still hampered by their exponential running time to solve this problem (unless NP=P).

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a relation between optimization problems and corresponding physical systems.

FIG. 2 discloses aspects of an example of a quantum annealing workflow.

FIG. 3 discloses an illustration of the embedding problem.

FIGS. 4a, 4b, and 4c, disclose an example application of the evolution of a post-processed physical graph into a disconnected graph.

FIG. 5 discloses an example method according to an embodiment.

FIG. 6 discloses some examples of effects resulting from removal of edges from a graph.

FIG. 7 discloses aspects of an example embodiment of a computing entity, which may comprise classical and/or quantum components, including annealers, configured and operable to perform part, or all, of any of the disclosed methods, processes, and operations.

### DETAILED DESCRIPTION OF SOME EXAMPLE EMBODIMENTS

Embodiments of the present invention generally relate to mapping of QUBO graph nodes to qubits implemented in hardware. More particularly, at least some embodiments of the invention relate to systems, hardware, software, computer-readable media, and methods, for a post-processing approach for reducing the number of qubits needed to solve a QUBO or other problem.

One example embodiment comprises a method for reducing, or minimizing, the number of physical qubits needed to solve a problem such as a QUBO. Let G=(V, E) be an undirected graph representing the quantum annealing hardware, where V is the set of physical qubits (or nodes) and E is the set of edges connecting each pair of physical qubits. One example of such a method comprises the following operations: computing a ranking list R of all edges of G, where the ranking is made in increasing order according to their connection coefficients, and each coefficient indicates how strong two qubits are entangled in the QA system—the coefficients may be obtained by looking the original QUBO graph; creating a copy of G, which is denoted as G′; and, for each edge e∈R, in ranked order, performing the following operations:
(a) breaking the loop, that is, not performing the operations (b) through (d) for the remaining e, if any stopping criteria is met-in one embodiment, for this criterion, a threshold may be predefined for discarding weak entanglements based on the connection coefficient, which stops the loop if the entanglement coefficient of e violates this threshold-another example, stopping criterion may consider using a maximum number of edges to be discarded in G′ or, reversely, the minimum number of edges that G′ must contain;
(b) using Tarjan's algorithm (TA) on G′ to identify the set of articulations A (nodes) and the set of bridges B (edges);
(c) removing from B all edges that have at least one node with adjacency degree equal to one—that is, nodes with only one edge—and placing the removed edges into B′;
(d) applying a set subtraction operation to remove all edges of B′ from R, that is, R=R−B′—this update maintains the ordering criteria of R, that is, the ranking list that was computed for all edges of G; and
(e) removing e from G′.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may reduce, possibly to a minimum, the number of qubits, which may be physical qubits, needed to solve a QUBO or other problem. Various other advantages of one or more example embodiments will be apparent from this disclosure.

### A. Context for an Example Embodiment

The following is a discussion of aspects of an example context for various embodiments of the invention. This discussion is not intended to limit the scope of the invention, or the applicability of the embodiments, in any way.

### A.1 Qubo Optimization Problems

A QUBO is a type of combinatorial optimization problem that enables many real-world problems to be encoded in the following format:

$$H ( x ) = {\sum }_{i < j} {q}_{i , j} {x}_{i} {x}_{j} + {\sum }_{i} {q}_{i} {x}_{i}^{2} = {x}^{T} Qx$$

Where x∈{0,1}ⁿ.

### A.2 Quantum Annealing

Quantum Annealing (QA) tries to interpolate between a static problem-independent Hamiltonian for which the ground state can be efficiently prepared, and a final Hamiltonian whose ground state yields the desired answer. The QA system then linearly interpolates between H₀ and H_{f} (H_{f}=Q).

$$H ( t ) = α ( t ) {H}_{0} + β ( t ) {H}_{f}$$

Where: H_{f} is the Hamiltonian of the problem to be solved.

This system represented by H (t) evolves following the time-dependent Schrodinger equation. The system is manipulated in the manner of creating a quantum tunneling effect that makes that the system stay closer to the ground state.

### A.3 Quantum Annealing Intuition

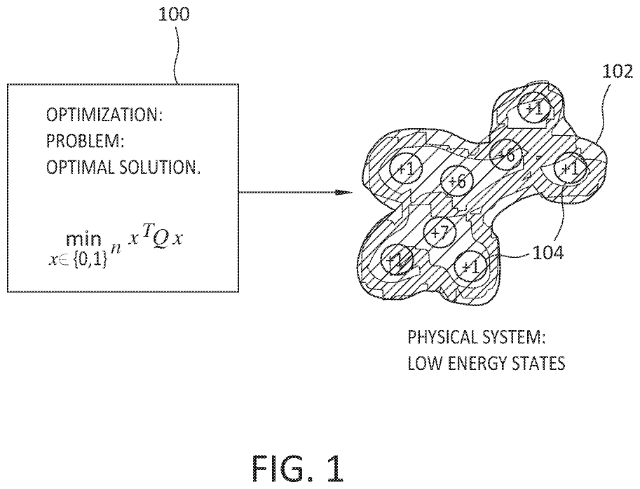

With reference briefly to FIG. 1, a solution to an optimization problem 100, such as a QUBO for example, may be thought of as being analogous to, or equating in some way to, a physical system 102. More specifically, the physical system 102 may have a variety of different low energy states 104, which may be referred to as local minima, each of which may comprise or corresponds to a respective solution to the optimization problem 100. The lowest energy state 104 may correspond to the optimal solution to the optimization problem 100.

### A.4 Example Quantum Annealing Workflow

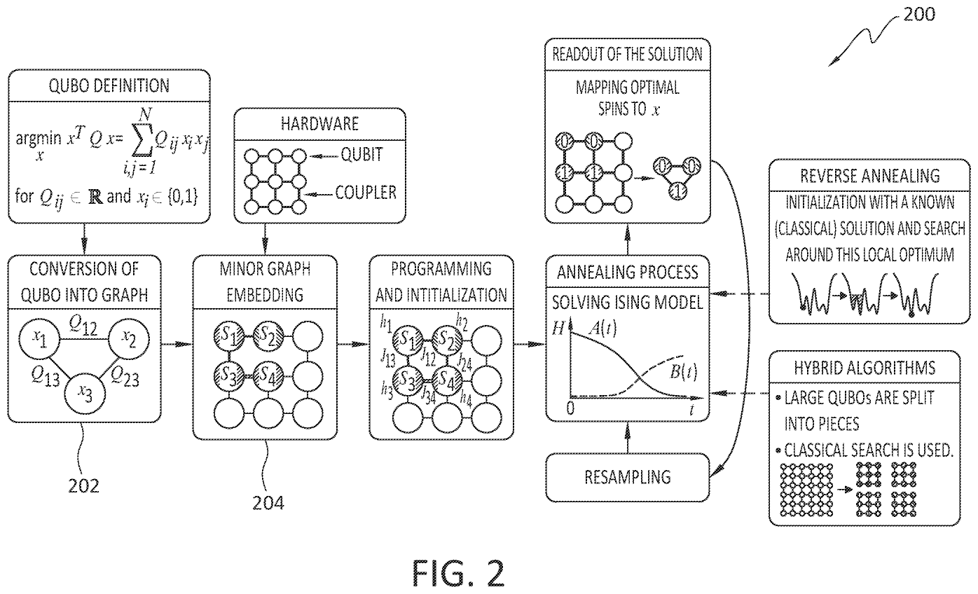

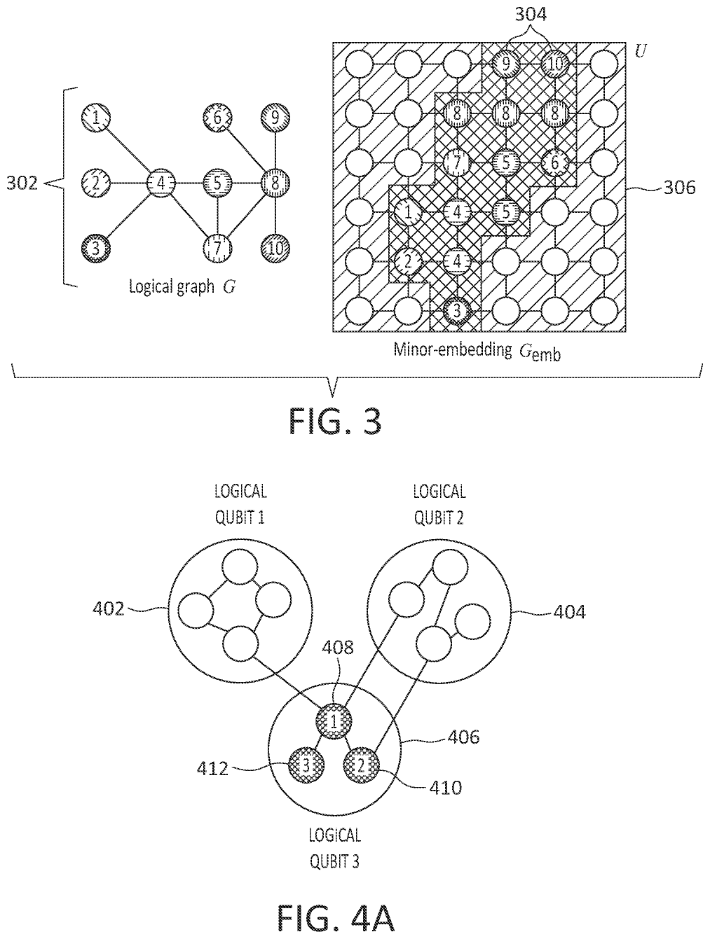

FIG. 2 discloses an example quantum annealing workflow 200. A conversion 202 of a QUBO into a graph may necessitate a graph embedding process 204 which may implicate a minor embedding problem, as disclosed in the example of FIG. 3.

### A.5 The Minor Embedding Problem

With reference now to FIG. 3, in order to solve combinatorial optimization problems such as QUBOs, it is necessary to map graph nodes 302, such as may be obtained at 202 in the example of FIG. 2, to the qubits 304 implemented in the hardware 306. In practice, heuristics may be used for this mapping. However, weak embeddings can drastically reduce the number of qubits in the hardware that are available for computation, which in turn may prevent the resolution of larger problem instances.

### B. Context for an Example Embodiment

One or more example embodiments may be suitable for solving various problems. For example, an embodiment may address a circumstance in which some embedded qubit connections may be so weak, that is, they may have smaller qubit multiplication coefficients, that they do not participate in high-quality solutions but are accounted in the physical graph, thus, increasing the complexity of the solving process.

As another example, an embodiment may address the fact that, in conventional approaches, preprocessing an input graph to remove some edges does not necessarily imply having embeddings with fewer qubits. Rather, this operation may only eliminate a connection with the same final number of qubits at the physical graph after the minor embedding problem.

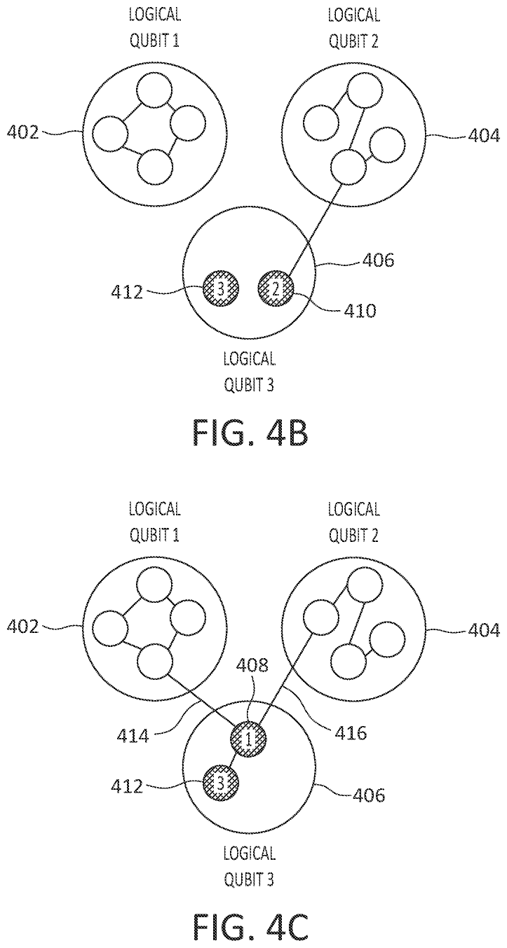

Finally, post-processing an embedded graph by removing edges is not a trivial task, and conventional approaches are not well suited, if at all, to implement the post-processing that may be needed in some circumstances. In particular, a very specific subset of edges is eligible to be removed to avoid the post-processed physical graph becoming a disconnected graph, as seen in the example of FIGS. 4a, 4b, and 4c, discussed below.

In particular, FIGS. 4a through 4c disclose a representation of a graph after applying a minor embedding approach to the original QUBO with three logical qubits 402, 404, and 406, as shown in FIG. 4a. FIG. 4a further discloses three physical qubits 408, 410, and 412, of the logical qubit 406, that are all connected. That is, the physical qubits (3) 412 and (2) 410 are connected to each other by way of the physical qubit (1) 408.

Thus, it can be seen in FIG. 4b that if the physical qubit (1) 408 is eliminated, the logical qubits 402(1) and 406 (3) become disconnected from each other. Further, physical qubit 410 (2) is thereby disconnected from physical qubit 412 (3), as a result of the elimination of the physical qubit (1) 408, resulting in a graph that is not equivalent to the original QUBO that is shown in FIG. 4a.

On the other hand, and with reference now to the example of FIG. 4c, even if qubit (2) 410 is disconnected from the qubit 408 (1), all the connections 414 and 416 between the logical qubits 402, 404, and 406 remain. As such, the problem of FIG. 4c remains equivalent to the original QUBO as it was configured before the qubit (2) 410 was disconnected.

### C. Aspects of an Example Method According to One Embodiment

### C.1 Introduction

In order to utilize use fewer qubits on a physical graph, an embodiment may comprise a post-processing approach constructed to reduce the number of connections among physical qubits. As a result, it is expected that the hardware may be able to optimize a QUBO problem much faster than usual, since fewer physical qubits may be expected to be employed.

In other words, the output of a method according to one embodiment is a new embedding with less usage of physical qubits that will be sent to the quantum hardware. In an embodiment however, this approach may come with a price of decreasing solution quality in a case where the removed connections may participate, or may have participated, in high-quality solutions. In practice however, an embedding obtained by an embodiment may reflect an assumption that (a) less important qubit connections rarely appear high-quality solutions, and that (b) an indicator may be used to identify such a circumstance, as discussed below. Thus, one embodiment may be best suited for QUBOs that are less sensitive to the absence of weak qubit connections.

### C.2 Example Method

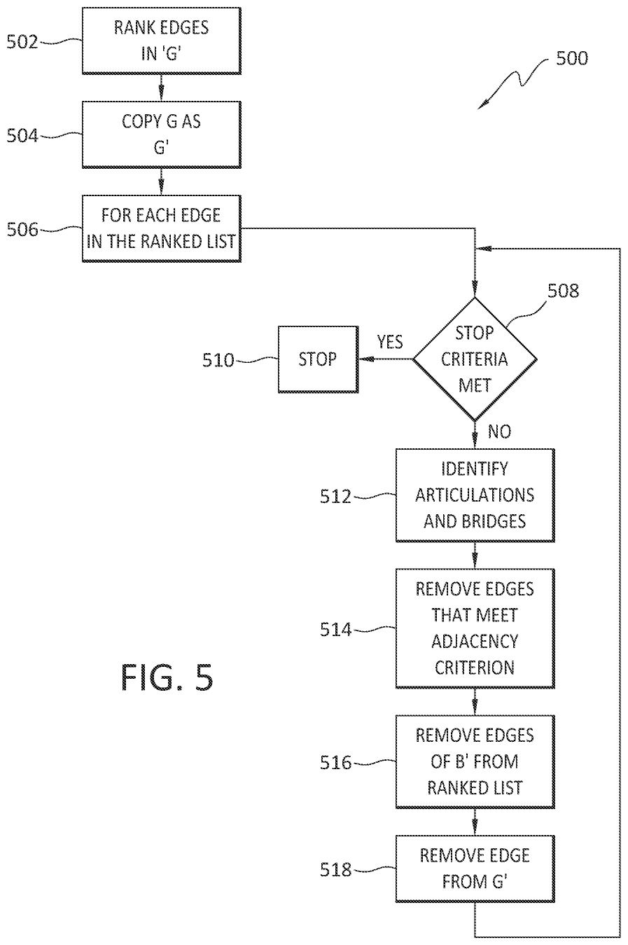

With reference now to FIG. 5, an example method according to one embodiment is denoted at 500. By way of background for the method 500, let G be the resulting graph of a minor embedding heuristic on Q, the QPU graph topology. The task of an example embodiment is, therefore, to remove as many edges as possible from G in a way that the resulting graph G′ can be more efficiently solved on Q by using fewer qubits, that is, nodes of Q, than are included in G. The example method 500 may proceed as set forth below.

The example method 500 may begin with computing 502 a ranking list R of all edges of G, where the ranking is made in increasing order according to their connection coefficients, and each coefficient indicates how strong two qubits are entangled in the QA system—the coefficients may be obtained by looking the original QUBO graph; creating 504 a copy of G, which is denoted as G′; and, for each edge e∈R, in ranked order, performing 506 the following operations:
checking 508 to determine if a stopping criteria is met, and breaking 510 the loop, that is, not performing the operations (b) through (d) for the remaining e, if any stopping criteria is met-in one embodiment, for this criterion, a threshold may be predefined for discarding weak entanglements based on the connection coefficient, which stops the loop if the entanglement coefficient of e violates this threshold-another example, stopping criterion may consider using a maximum number of edges to be discarded in G′ or, reversely, the minimum number of edges that G′ must contain;
(b) using Tarjan's algorithm (TA) on G′ to identify 512 the set of articulations A (nodes) and the set of bridges B (edges);
(c) removing 514 from B all edges that have at least one node with adjacency degree equal to one—that is, nodes with only one edge—and placing the removed edges into B′;
(d) applying a set subtraction operation to remove 515 all edges of B′ from R, that is, R=R−B′—this update maintains the ordering criteria of R, that is, the ranking list that was computed for all edges of G; and
(e) removing 518 e from G′.

In an embodiment, an algorithm that implements the method 500 may, in a worst-case scenario, have a time complexity O(|E|(|V|+|E|)), where |E| stands for the cardinality of the set of edges and |V| is the cardinality of the set of nodes of G. This complexity may be achieved since, at 506, the example method 500 may iterate over all edges, that is, |E|, and the running time of the TA is linear in the number of nodes and edges, that is, O(|V|+|E|). In practical terms, the size of R decreases at each iteration of 506 whenever |B′|>0, making this loop iterate in a limited number of edges that may be less than the total edges |E|.

### C.3 Additional Information Concerning an Example Embodiment of a Method

Reference is made herein to Tarjan's algorithm, which is disclosed in “Tarjan, R. (1972). Depth-first search and linear graph algorithms. SIAM journal on computing, 1 (2), 146-160. https://ieeexplore.ieee.org/document/4569669,” which is incorporated herein in its entirety by this reference. In general, TA is a linear-time algorithm originally designed for detecting strongly connected components (SCCs) in graphs. The detection of bridges and articulations is a consequence of detecting SCCs by slight modifications in the original algorithm. The rationale consists of the removal of an edge (u,v) that creates a condition in which node u cannot reach node v by another path, then (u,v) is a bridge, and one or both nodes u and v are articulation points which, once removed, imply a disconnection in the graph.

It is noted that as used herein, an ‘articulation’ is a node such that its removal increases the number of connected components. As well, a ‘bridge’ is an edge such that its removal increases the number of connected components.

As to such articulations and bridges, it is further noted that the number of connected components will never decrease, but this number can increase or keep the same. That is, it may be assumed, in one embodiment at least, that a connected component is a set of nodes such that every node of this set can reach all nodes of the same set. As such, a removal of a bridge will necessarily break a graph formed by a single connected component into a graph composed of two connected components.

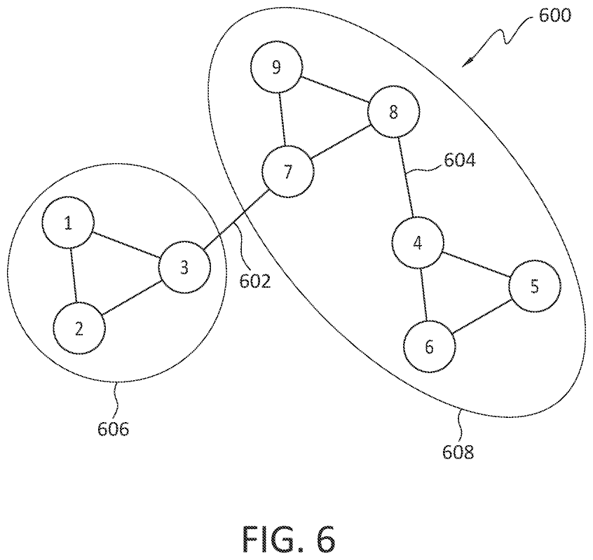

Put another way, the removal of a node, or edge, as applicable, will increase the number of connected components as long as the node is an articulation, or the edge is a bridge, as applicable. If a removed node, or edge, is not an articulation, or a bridge, the number of connected components will not change once this removal does not at all imply in “breaking” the graph into two connected components. The following discussion of FIG. 6 addresses some of these points.

In FIG. 6, a graph G is denoted at 600, and initially comprises a single connected component and two bridges 702 and 704. Next, suppose that edge 602 is removed. The two connected components 606 and 608 with nodes {1,2,3} and {4,5,6,7,8,9}, respectively, will still exist after the removal of the edge 602. This resulting graph, that is, after the removal of the edge 602, may then be referred to as G′.

With respect to G′, suppose further that the bridge 604 is now removed. Now, there are three connected components, namely, components respectively comprising the nodes {1,2,3}, {4,5,6} and {7,8,9}. As these two examples illustrate then, it is thus generally the case that the removal of k bridges will result in (k+1) connected components.

### D. Further Discussion

As will be apparent from this disclosure, one or more example embodiments may possess various useful features and aspects, although no embodiment is required to possess any of such features and aspects. The following examples are illustrative.

One example embodiment comprises a post-processing approach for making the resulting QPU embedding more efficient by using classical algorithms. In other words, the output of a method according to one embodiment is a new embedding, with less usage of physical qubits, that will be sent to the quantum hardware. As another example, an embodiment may operate to leverage graph properties and a simple ranking to implement an efficient general solution approach for embedding QUBO problems into real quantum annealing hardware.

### E. Further Example Embodiments

Following are some further example embodiments of the invention. These are presented only by way of example and are not intended to limit the scope of the invention in any way.

Embodiment 1. ranking all edges e of a graph G that was obtained using a minor embedding process performed on a graph topology Q, and the ranked edges are included in a list R; creating a graph G′ by copying G; and for each of the edges e, performing, for as long as a stop criterion has not been met, operations comprising: identifying nodes and edges in the graph G′; removing, from the graph G′, any edges that meet an adjacency criterion, and placing the removed edges in a set B′ of edges; removing, from the list R, all edges of the set B′ of edges; and removing, from the graph G′, the edge e.

Embodiment 2. The method as recited in any preceding embodiment, wherein the graph G′ maps the nodes to qubits implemented in hardware.

Embodiment 3. The method as recited in any preceding embodiment, wherein the graph G′ does not include any disconnected qubits.

Embodiment 4. The method as recited in any preceding embodiment, wherein qubits identified in the graph G′ are a minimum number of qubits needed in a real quantum annealer to solve a quadratic unconstrained binary optimization problem.

Embodiment 5. The method as recited in any preceding embodiment, wherein the edges e are ranked according to their respective connection coefficient.

Embodiment 6. The method as recited in any preceding embodiment, wherein the graph G′ has fewer edges than the graph G.

Embodiment 7. The method as recited in any preceding embodiment, wherein the stop criterion specifies a threshold for discarding a weak entanglement based on respective connection coefficients of the edges e.

Embodiment 8. The method as recited in any preceding embodiment, wherein the stop criterion specifies a minimum number of edges that the graph G′ must contain.

Embodiment 9. The method as recited in any preceding embodiment, wherein the adjacency criterion specifies that an edge that has at least one node with an adjacency degree equal to one should be removed from the graph G′.

Embodiment 10. The method as recited in any preceding embodiment, wherein the nodes and edges are identified using Tarjan's algorithm.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

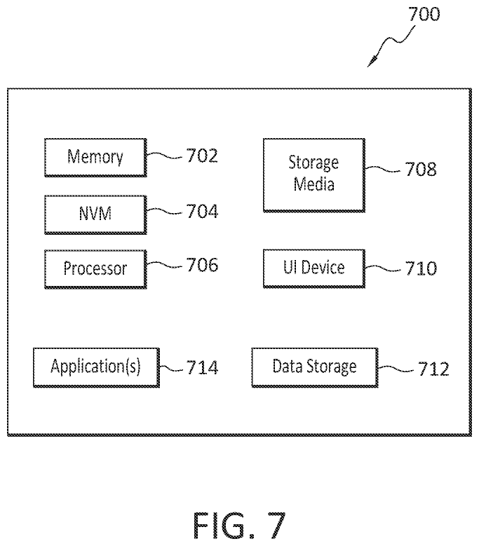

With reference briefly now to FIG. 7, any one or more of the entities disclosed, or implied, by FIGS. 1-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
ranking all edges e of a graph G that was obtained using a minor embedding process performed on a graph topology Q, and the ranked edges are included in a list R;
creating a graph G′ by copying G; and
for each of the edges e, performing, for as long as a stop criterion has not been met, operations comprising:
identifying nodes and edges in the graph G′;
removing, from the graph G′, any edges that meet an adjacency criterion, and placing the removed edges in a set B′ of edges;
removing, from the list R, all edges of the set B′ of edges; and
removing, from the graph G′, the edge e.

2. The method as recited in claim 1, wherein the graph G′ maps the nodes to qubits implemented in hardware.

3. The method as recited in claim 1, wherein the graph G′ does not include any disconnected qubits.

4. The method as recited in claim 1, wherein qubits identified in the graph G′ are a minimum number of qubits needed in a real quantum annealer to solve a quadratic unconstrained binary optimization problem.

5. The method as recited in claim 1, wherein the edges e are ranked according to their respective connection coefficient.

6. The method as recited in claim 1, wherein the graph G′ has fewer edges than the graph G.

7. The method as recited in claim 1, wherein the stop criterion specifies a threshold for discarding a weak entanglement based on respective connection coefficients of the edges e.

8. The method as recited in claim 1, wherein the stop criterion specifies a minimum number of edges that the graph G′ must contain.

9. The method as recited in claim 1, wherein the adjacency criterion specifies that an edge that has at least one node with an adjacency degree equal to one should be removed from the graph G′.

10. The method as recited in claim 1, wherein the nodes and edges are identified using Tarjan's algorithm.

11. A non-transitory storage medium having stored therein instructions that are executable by one or more hardware processors to perform operations comprising:
ranking all edges e of a graph G that was obtained using a minor embedding process performed on a graph topology Q, and the ranked edges are included in a list R;
creating a graph G′ by copying G; and
for each of the edges e, performing, for as long as a stop criterion has not been met, further operations comprising:
identifying nodes and edges in the graph G′;
removing, from the graph G′, any edges that meet an adjacency criterion, and placing the removed edges in a set B′ of edges;
removing, from the list R, all edges of the set B′ of edges; and
removing, from the graph G′, the edge e.

12. The non-transitory storage medium as recited in claim 11, wherein the graph G′ maps the nodes to qubits implemented in hardware.

13. The non-transitory storage medium as recited in claim 11, wherein the graph G′ does not include any disconnected qubits.

14. The non-transitory storage medium as recited in claim 11, wherein qubits identified in the graph G′ are a minimum number of qubits needed in a real quantum annealer to solve a quadratic unconstrained binary optimization problem.

15. The non-transitory storage medium as recited in claim 11, wherein the edges e are ranked according to their respective connection coefficient.

16. The non-transitory storage medium as recited in claim 11, wherein the graph G′ has fewer edges than the graph G.

17. The non-transitory storage medium as recited in claim 11, wherein the stop criterion specifies a threshold for discarding a weak entanglement based on respective connection coefficients of the edges e.

18. The non-transitory storage medium as recited in claim 11, wherein the stop criterion specifies a minimum number of edges that the graph G′ must contain.

19. The non-transitory storage medium as recited in claim 11, wherein the adjacency criterion specifies that an edge that has at least one node with an adjacency degree equal to one should be removed from the graph G′.

20. The non-transitory storage medium as recited in claim 11, wherein the nodes and edges are identified using Tarjan's algorithm.
